(19) United States
(12) Patent Application Publication
(10) Pub. No.: US 2013/0191746 A1
(43) Pub. Date: Jul. 25, 2013

(54) TIMELINE CONTROL METHOD FOR FAST RETURNING TO START TIME OF AN EVENT LOG

(71) Applicant: ACTI Corporation, Taipei City (TW)

(72) Inventors: YAN-HAO HUANG, TAIPEI CITY (TW); CHING-WEN LI, NEW TAIPEI CITY (TW)

(73) Assignee: ACTI CORPORATION, TAIPEI CITY (TW)

(21) Appl. No.: 13/740,821

(22) Filed: Jan. 14, 2013

(30) Foreign Application Priority Data
Jan. 19, 2012 (TW) 101102233

(51) Int. Cl. G06F 3/0484

(52) U.S. Cl. CPC G06F 3/0484
USPC 715/716

(57) ABSTRACT

A timeline control method for fast returning to start time of an event log which is executed in a monitoring system with at least a timeline in a monitoring window; the monitoring window is able to display a return point at a timeline when a start marker for an event log is not observed at the timeline which is dragged by a user. Moreover, the present disclosure also realizes effects such as the start marker quickly recovered at the timeline in the monitoring window, images for an event log played in the monitoring window, and the start time for the event log observed quickly when the return point is clicked.

### BACKGROUND OF THE INVENTION

1. Field of the Invention

The present disclosure relates to a timeline control method for fast returning to start time of an event log, particularly the timeline control method executed in a monitoring window of a monitoring system.

2. Description of the Related Art

The ordinary digitalized security monitoring systems developed with up-to-date technologies are based on images monitored and recorded by supervisory devices to guard against burglars, ensure safety, and facilitate gathering of evidences afterward or real-time crime prevention. Moreover, most existing monitoring systems are characteristics of multiple event detection modes, which setup event logs for occurrence of all events in a monitoring system, and provide gathered evidences or data to a remote monitoring center for immediately monitoring and dealing with any unusually event.

In accordance with attributes of sensors, the event detection modes known to persons in the art can be classified into motion detection, alarm detection, and IR (infrared) detection: (1) motion detection refers to detecting any motion of a person, an object or an animal in frames monitored and recorded by a supervisory device; (2) alarm detection refers to detecting any unusual state such as temperature or an open door by sensors in one position under surveillance; (3) IR detection refers to detecting any movement or invasion of an object by infrared. An event log can be setup in a security monitoring system by a supervisory device, which may depends on any detection mode hereinbefore.

It is possible that a user who intends to find criminal evidences or unusual states in event logs covering a long period of time needs to spend a lot of time and repeatedly check event logs. However, a timeline T for one event log in an ordinary monitoring window W has a limited length L which induces a user to drag the timeline T back and forth in order to return to start time S of the event log (FIG. 1). As such, the efficiency of repeatedly checking more than one long event log covering a long period of time is seriously affected because faults are generated easily in dragging a timeline back and forth and an event log is also mistakenly deleted or missed easily.

Accordingly, a timeline control method for fast returning to start time of an event log is the subject in the present disclosure.

### SUMMARY OF THE INVENTION

The present disclosure is intended for providing a timeline control method for fast returning to start time of an event log, which is executed in a monitoring system with at least a timeline in a monitoring window, and is shown in steps hereinafter:

Step 1 (S1): Play an event log with start time for the event log indicated at a timeline in the monitoring window;

Step 2 (S2): Mark the start time as a start marker for the event log;

Step 3 (S3): Drag a timeline to controllably forward play or rewind images for the event log;

Step 4 (S4): Determine whether the start marker for the event log is observed in the monitoring window or not (if “Yes”: go to Step 5; if “No”: return to Step 3);

Step 5 (S5): Display a return point at the timeline in the monitoring window when the start marker for the event log is not observed in the monitoring window;

Step 6 (S6): After the return point is clicked, display the start marker for the event log at the timeline in the monitoring window and play images of the start time for the event log .

In light of objectives and features hereinbefore, the monitoring window is provided with a search field, which is employed in searching an event log based on time for construction or various categories of event logs, and is used in playing a targeted event log.

In light of objectives and features hereinbefore, a newly added event log, if any, can be directly displayed in an event list inside the monitoring window for a user who needs to browse and choose any event log thereon.

In light of objectives and features hereinbefore, the event log can be activated to play a real-time event images automatically or rewind event images with no selection of a user required.

In light of objectives and features hereinbefore, the start marker for the event log in Step 2 (S2) is centrally shown at the timeline in the monitoring window and quickly recognized as start time for the event log by a user.

In light of objectives and features hereinbefore, the start marker for the event log in Step 6 (S6) is centrally shown at the timeline in the monitoring window.

In light of objectives and features hereinbefore, a return point is indicated at either a front end or a rear end of the timeline in the monitoring window when the start marker for the event log is not observed in the monitoring window.

In light of objectives and features hereinbefore, both the start time and the end time for the event log are indicated at the timeline in the monitoring window and the timeline from the start time to the end time is partially colored with a distinct hue differentiated from other parts of the timeline.

In light of objectives and features hereinbefore, the monitoring system is executed in a host computer.

### BRIEF DESCRIPTION OF THE DRAWINGS

FIG. 1 is a schematic view illustrating start time for an event log disappearing from one side of a timeline in a prior art.

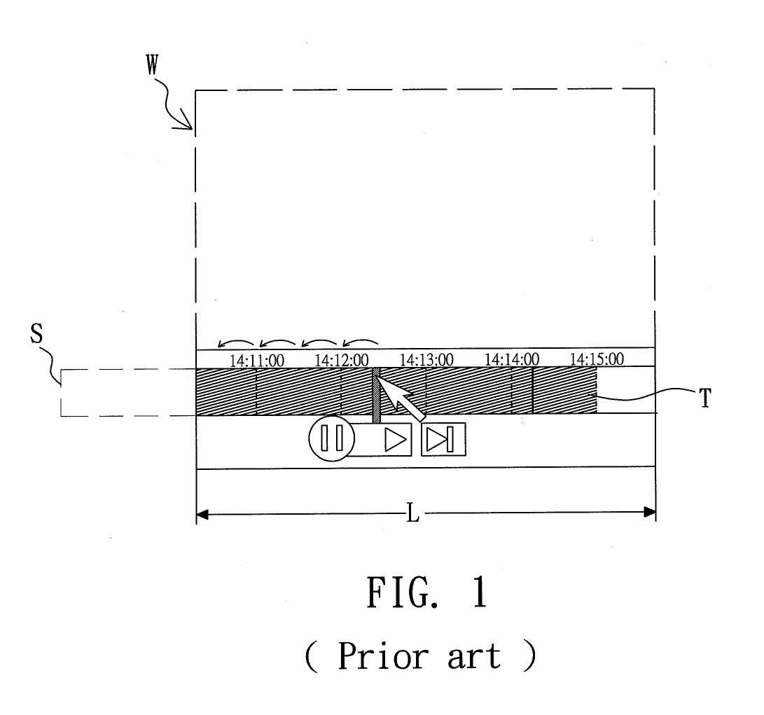

FIG. 2 is a flowchart of the present disclosure in one embodiment.

FIG. 3 is a schematic view illustrating a monitoring window of the present disclosure wherein both start time and end time are shown at a timeline.

FIG. 4 is a schematic view illustrating a further partial monitoring window of the present disclosure with a timeline at which there is no start time.

FIG. 5 is a schematic view illustrating yet a further monitoring window of the present disclosure in which an event list is prepared for a user who intends to browse and select any event log therein.

### DETAILED DESCRIPTION OF THE PREFERRED EMBODIMENTS

In light of objectives and features mentioned hereinbefore, the preferred embodiments along with accompanying drawings are presented hereinafter and illustrate technical measures and effects of the present disclosure.

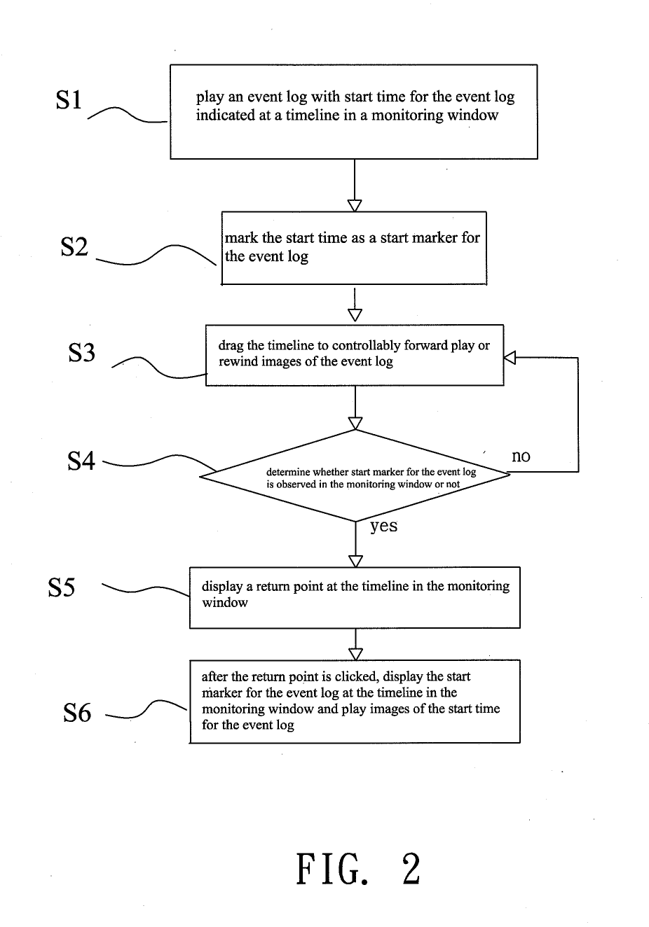

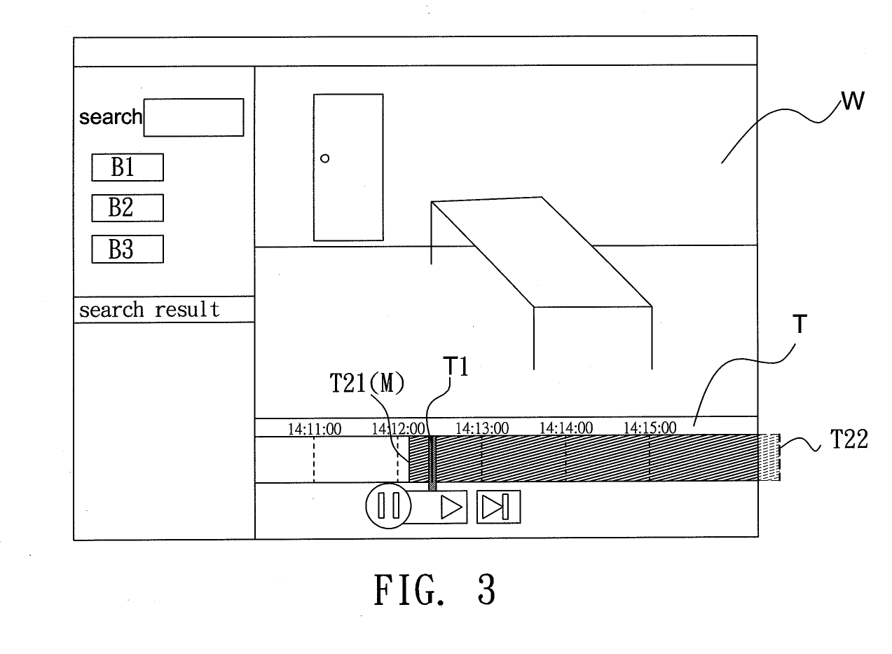

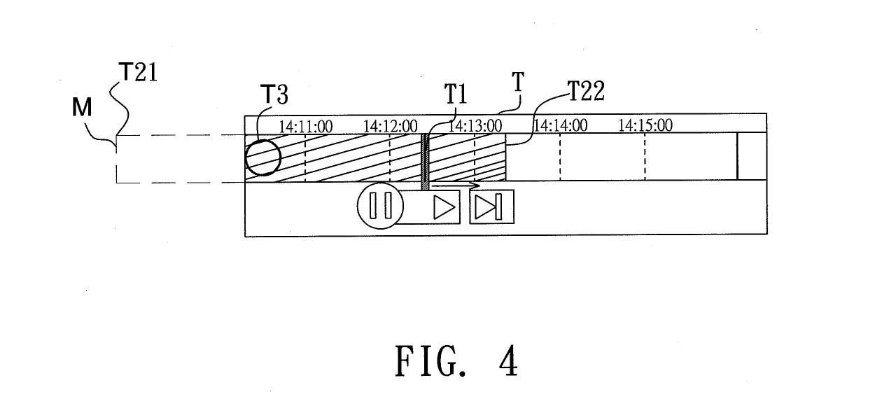

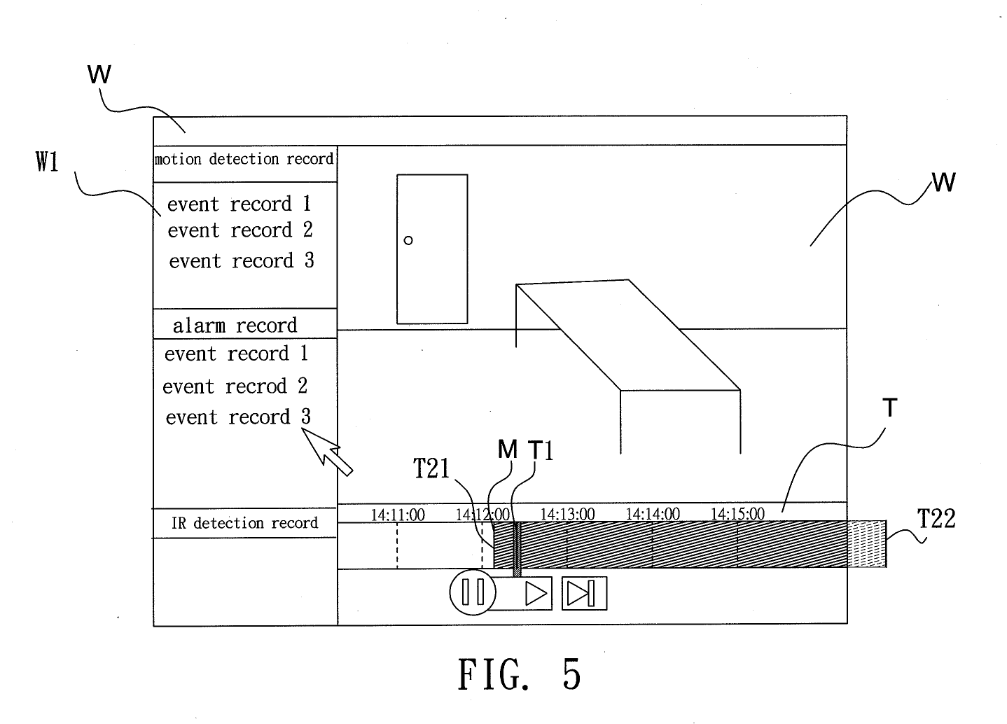

Referring to FIG. 2 through FIG. 5: FIG. 2 is a flowchart of the present disclosure in one embodiment; FIG. 3 is a schematic view illustrating a monitoring window of the present disclosure in which there is a timeline with both start time and end time; FIG. 4 is a schematic view illustrating a further partial monitoring window with a timeline in which there is no start time; FIG. 5 is a schematic view illustrating yet a further monitoring window of the present disclosure in which an event list is prepared for a user who intends to browse and select any event log therein.

As shown in these figures, the present disclosure provides a timeline control method for fast returning to start time of an event log in one embodiment wherein the method is executed in a monitoring system with at least a timeline T displayed in a monitoring window W and equipped with a trim pointer T1 which is used to indicate time for images displayed. The monitoring window W is provided with a search field by which a user may make a search and order by referring to time for construction or various categories of event logs or directly configures buttons for different event logs, for example, detected motion record button B1, detected alarm record button B2, and detected IR record button B3 as a user's option used to directly choose to search and browse the multiple category-based event logs (FIG. 3) and not specifically limited herein.

As shown in Step 1 (S1), start time T21 for an event log which is played is indicated at the timeline T in the monitoring window W.

As shown in Step 2 (S2), a start marker M for the event log is marked on the start time T21 at the timeline T.

As shown in Step 3 (S3), the event log is directly played or the timeline T is freely dragged by a user to controllably forward play or rewind images of the event log.

As shown in Step 4 (S4), after Step 3 is executed, determine whether the start marker M (start time T21) for the event log is observed at (or disappearing from) one side of the monitoring window W or not (if “Yes”: go to Step 5; if “No”: return to Step 3);

As shown in Step 5 (S5), the event log indicated in the timeline T is directly executed or any position of the timeline T is dragged: the start marker M for the event log is shifted together with the timeline T relatively. When the start marker M (start time T21) for the event log is shifted to one end of the timeline T and disappearing in the monitoring window W with the timeline T continuously moving, a return point T3 is shown at the timeline T in the monitoring window W (FIG. 4), for example, the return point T3 is designed at the rear (left) end of the timeline T and referred to as one symbol indicating the start marker M for the event log at the rear (left) end of the timeline T when the start marker M (start time T21) for the event log disappears at the rear (left) end of the timeline T;

As shown in Step 6 (S6), the start time T21 for the event log quickly reappears at the timeline T in the monitoring window W when the return point T3 is clicked by a user, who intends to re-browse the event log starting from the start time T21, with no need to drag the timeline T back and forth.

In the present disclosure, the monitoring window W is provided with a search field by which a user may make a search for event logs by referring to time for construction or various categories of event logs and choose the targeted event log to play.

The present disclosure is capable of immediately displaying a newly added event log, if any, in an event list W1 inside the monitoring window W for a user who needs to browse and choose any event log thereon; the event list W1 inside the monitoring window W comprises event logs sorted or classified based on time for production or activated categories in advance (FIG. 5) fora user who may quickly browse and choose any targeted event log thereon.

Furthermore, the present disclosure is able to automatically play any real-time event images and rewind images which have occurred with the event log activated and no browse and selection of one user required. Moreover, the present disclosure is able to predetermine automatic displaying of a real-time event images by setting the categories of some specific events occurring as references of a monitor in response to one type of events, for example, the category of a detected alarm event which has been activated is automatically played in real time.

In Step 2 (S2) of the present disclosure, the start marker M for an event log is centrally indicated at the timeline T in the monitoring window W for a user who may quickly recognize start time T21 of the event log.

In Step 6 (S6) of the present disclosure, the start marker M for an event log is centrally indicated at the timeline T in the monitoring window W.

In the present disclosure, the return point T3 can be indicated at either a front (right) end or a rear (left) end of the timeline T in the monitoring window W when the start marker M for an event log is not observed in the monitoring window W.

In the present disclosure, both the start time T21 and the end time T22 for an event log can be indicated at the timeline T in the monitoring window W; the timeline T from the start time T21 to the end time T22 is partially colored with a distinct hue differentiated from other parts of the timeline T.

In the present disclosure, the monitoring system is executed in a host computer.

The present disclosure is specifically described in but not limited to the preferred embodiments; any changes or modifications without departing from the spirit of the present disclosure shall be within the scope of the present invention.

What is claimed is:

1. A timeline control method for fast returning to a start time of an event log which is executed in a monitoring system with at least a timeline in a monitoring window and comprises steps as follows:
Step 1 (S1): Play said event log with said start time for said event log indicated at said timeline in said monitoring window;
Step 2 (S2): Mark said start time as a start marker for said event log;
Step 3 (S3): Drag said timeline to controllably forward play or rewind images of said event log;
Step 4 (S4): Determine whether said start marker for said event log is observed in said monitoring window or not (if “Yes”: go to Step 5; if “No”: return to Step 3);
Step 5 (S5): Display a return point at said timeline in said monitoring window when said start marker for said event log is not observed in said monitoring window;
Step 6 (S6): After said return point is clicked, display said start marker for said event log at said timeline in said monitoring window.

2. The timeline control method for fast returning to start time of an event log according to claim 1 wherein said monitoring window is provided with a search field, which is employed in searching said event log based on different constructed time or categories of even logs, and is used in playing said event log which is targeted.

3. The timeline control method for fast returning to start time of an event log according to claim 1 wherein said event log is shown in an event list inside said monitoring window for a user who intends to browse and select said event log.

4. The timeline control method for fast returning to start time of an event log according to claim 1 wherein said event log can be activated to play a real-time event images automatically.

5. The timeline control method for fast returning to start time of an event log according to claim 1 wherein said start marker for said event log in Step 2 is centrally shown at said timeline.

6. The timeline control method for fast returning to start time of an event log according to claim 1 wherein said start marker for said event log in Step 6 is centrally shown at said timeline.

7. The timeline control method for fast returning to start time of an event log according to claim 1 wherein said start marker is displayed in Step 6, and then images starting from said start time for said event log are played.

8. The timeline control method for fast returning to start time of an event log according to claim 1 wherein said return point is indicated at a front end of said timeline in said monitoring window.

9. The timeline control method for fast returning to start time of an event log according to claim 1 wherein said return point is indicated at a rear end of said timeline in said monitoring window.

10. The timeline control method for fast returning to start time of an event log according to claim 1 wherein said timeline from said start time to an end time for said event log is partially colored with a distinct hue differentiated from other parts of said timeline.

11. The timeline control method for fast returning to start time of an event log according to claim 1 wherein said monitoring system is executed in a host computer.
